(19) United States
(12) Patent Application Publication
(10) Pub. No.: US 2016/0297688 A1
(43) Pub. Date: Oct. 13, 2016

(54) SYSTEM AND METHOD FOR REMOVING SOLIDS AND HYDROCARBONS FROM WATER

(71) Applicant: Amcol International Corporation, Hoffman Estates, IL (US)

(72) Inventors: Jarid Byron Hugonin, Lafayette, LA (US); Elliot Francis Halphen, New Iberia, LA (US)

(21) Appl. No.: 14/681,864

(22) Filed: Apr. 8, 2015

(51) Int. Cl. C02F 1/24; B01D 17/02; B01D 33/41

(52) U.S. Cl. CPC C02F 1/24; B01D 33/41; B01D 17/0214; C02F 2101/32

(57) ABSTRACT

Oil, grease, and other hydrocarbons which are emulsified and/or entrained in water can be removed by first removing any solids from the water and then passing the contaminated water through media configured to coalesce the hydrocarbon contaminants. The coalesced hydrocarbon contaminants are allowed to float above the water, at which point the hydrocarbon contaminants can easily be removed from the water.

### FIELD

The present invention relates to removal of solids and hydrocarbons from water.

### BACKGROUND

There are many situations that require cleaning of water. For example, extraction of oil and gas from beneath the seafloor involves water which is mixed with oil and gas. The water mixture is referred in the art as produced water. The oil and gas must be removed from the produced water before the oil and gas is transported to a refinery. Also, oil, grease and other hydrocarbons are unavoidably spilled on work decks of offshore drilling and production platforms. These and other contaminants are washed off the decks by water or rain into collection vessels where the contaminants are removed so that they do not pollute the ocean.

Hydrocarbons can be removed from water in various ways, such as described in U.S. Pat. No. 7,297,279. However, there is a continuing need to increase the efficiency of removal within the confines of available space, which can be limited on certain offshore and inland drilling installations. For example, a drilling installation may receive heavy rains that can overwhelm conventional water cleaning systems incapable of high flow cleaning Also, dirt and other solid contaminants in the water may degrade the performance of hydrocarbon removal equipment, which results in downtime and increased costs to replace or clean certain parts of the equipment.

Accordingly, there is a continuing need for a system and method to remove hydrocarbons and other contaminants in the water with greater efficiency in terms of the use of available space, amount of water, and cost.

### BRIEF DESCRIPTION OF THE DRAWINGS

FIG. 1 is a schematic diagram showing an exemplary system for cleaning water.

FIG. 2 is a schematic cross-section view showing an exemplary solids collection vessel for the system of FIG. 1, the solids collection vessel having a filtration chamber in a compressed state.

FIG. 3 is a schematic cross-section view showing the solids collection vessel of FIG. 2 with the filtration chamber in an enlarged state.

FIG. 4 is a schematic cross-section view showing an exemplary hydrocarbon collection vessel for the system of FIG. 1.

FIG. 5 is a partial cutaway view showing an exemplary canister for holding coalescing media in the hydrocarbon collection vessel of FIG. 4.

FIG. 6 is a simplified representation of the coalescing media of FIG. 5.

FIG. 7 is a schematic cross-section view of an exemplary sump tank for the system of FIG. 1.

FIG. 8 is a flow diagram showing an exemplary method for cleaning water.

All drawings are schematic illustrations and the structures rendered therein are not intended to be in scale.

### SUMMARY

Briefly and in general terms, the present invention is directed to a system and method for cleaning water.

In aspects of the invention, a system comprises a solids collection vessel and a hydrocarbon collection vessel. The solids collection vessel is capable of receiving water containing solids and hydrocarbon contaminants entrained or emulsified in the water. The solids collection vessel includes a filtration chamber containing filtration media. The filtration chamber is configured to compress the filtration media to allow entrapment of the solids in the filtration media, and to decompress the filtration media to allow flushing of the solids out from the filtration media. The hydrocarbon collection vessel is disposed downstream of the solids collection vessel and is configured to receive the water from which solids have been removed. The hydrocarbon collection vessel contains coalescing media capable of coalescing the hydrocarbon contaminants to facilitate separation of the hydrocarbon contaminants from the water.

In aspects of the invention, a method comprises receiving water containing solids and hydrocarbon contaminants entrained or emulsified in the water, followed by removing the solids from the water, and removing the hydrocarbon contaminants from the water. The removing of solids includes trapping the solids in filtration media after the filtration media has been compressed, and flushing the solids from the filtration media after the filtration media has been decompressed. The removing of hydrocarbon contaminants includes passing the hydrocarbon contaminants, which are entrained or emulsified in the water, through coalescing media, followed by allowing coalesced hydrocarbon contaminants, which were coalesced by the coalescing media, to float above the water, and followed by discharging the coalesced hydrocarbon contaminants separately from water.

The features and advantages of the invention will be more readily understood from the following detailed description which should be read in conjunction with the accompanying drawings.

### DETAILED DESCRIPTION OF EXEMPLARY EMBODIMENTS

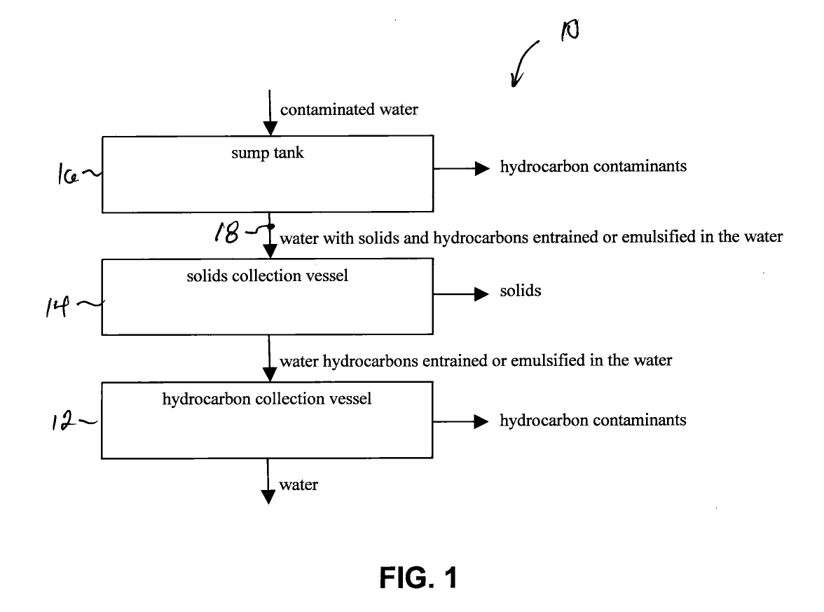

Referring now in more detail to the exemplary drawings for purposes of illustrating aspects of the invention, wherein like reference numerals designate corresponding or like elements among the several views, there is shown in FIG. 1 exemplary system 10 for removing solids and hydrocarbons from water. System 10 can be used in many different situations. For example and without limitation, system 10 can be installed on an oil drilling and production platform situated over the ocean or on land. System 10 can be used to clean produced water involved in extraction of oil or gas from below the seafloor. Also, system 10 can used to clean water runoff from the work decks of an offshore oil drilling and production platform. In addition system 10 can be mounted on a flatbed on wheels so that it can be brought wherever it is needed.

Hydrocarbon collection vessel 12 is used to remove hydrocarbon contaminants which are entrained and/or emulsified in the water. Such contaminants may include fine droplets of oil, grease, and other hydrocarbon contaminants which may not readily float above the water for removal. As described below, hydrocarbon collection vessel 12 includes coalescing media which cause hydrocarbon contaminants, which are entrained and/or emulsified in the water, to coalesce which aids in removal of the hydrocarbon contaminants. The coalescing media is capable of treating relatively high flows of water. However, dirt and other solids in the water may degrade the efficiency of the coalescing media.

Solids collection vessel 14 is used to remove solids from the water before the water reaches hydrocarbon collection vessel 12. As described below, solids collection vessel 14 includes filtration media that can easily be cleaned and used again, thereby reducing costs as compared to conventional solids removal equipment, such as pleated filters and the like, which must be removed from the equipment and replaced with a new filter.

Optionally, system 10 may include sump tank 16 to remove bulk quantities and large droplets of oil, grease, and other hydrocarbons which can float above the water before the water reaches solids collection vessel 14 and hydrocarbon collection vessel 12. This can increase the overall flow efficiency of system 10 as well as reduce the amount of maintenance and cleaning required of solids collection vessel 14 and hydrocarbon collection vessel 12.

Although system 10 is illustrated with one sump tank, one solids collection vessel, and one hydrocarbon collection vessel, it is to be understood that system 10 may include a greater number of these cleaning apparatuses. For example, two or more sump tanks can be arranged in parallel and/or in series with the water treatment flow. Additionally or alternatively, two or more solids collection vessels can be arranged in parallel and/or in series with the water treatment flow. Additionally or alternatively, two or more hydrocarbon collection vessels can be arranged in parallel and/or in series with the water treatment flow. For instance, the water flow at point 18 may split into two or more branches, with each branch having one solids collection vessel, so that there are three solids collection vessels arranged in parallel. For each branch, there can be two or more hydrocarbon collection vessels arranged in series or in parallel downstream of the solids collection vessel. The total number of cleaning apparatuses and their arrangement will depend on the water flow requirements and space restrictions of a particular installation.

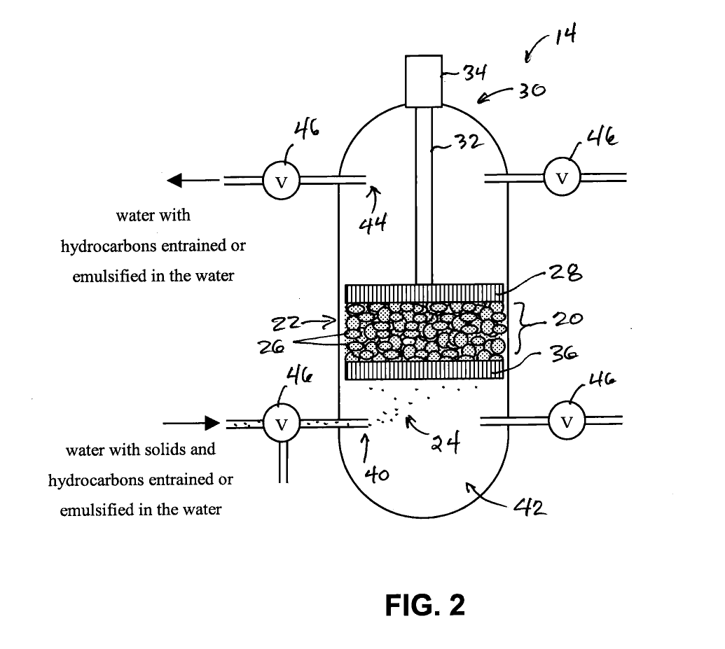

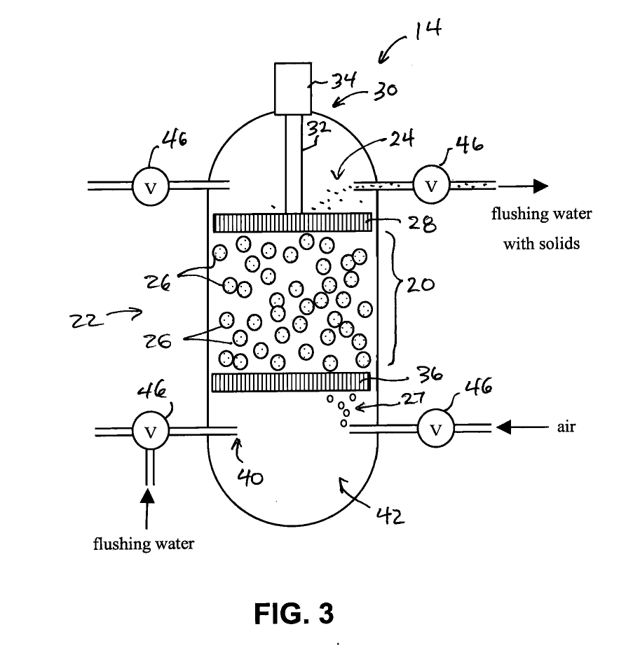

Referring to FIGS. 2 and 3, solids collection vessel 14 is capable of receiving water containing solids and hydrocarbon contaminants entrained and/or emulsified in the water. Solids collection vessel 14 includes filtration chamber 20 that contains filtration media 22. Filtration chamber 20 is configured to compress filtration media 22 to allow entrapment of solids 24 in solid filtration media 22 as shown in FIG. 2. Filtration chamber 20 is configured to decompress filtration media 22 to allow flushing of solids 24 out from filtration media 22 as shown in FIG. 3.

Filtration media 22 includes a plurality of individual filter components 26. Each component 26 is a bundle of synthetic fibers. The synthetic fibers can be bundled together with a metal wire. Each bundle of fibers forms a lump that is generally spherical in shape. Each fiber bundle 26 can be from 10 to 50 mm in diameter. The fibers may include polyvinylidene chloride fibers, polyvinylchloride fibers, polyethylene fibers, other synthetic polymer fibers, and/or combinations thereof. Each fiber can have a thickness from 20 to 200 denier. The fibers and bundles may be as described in U.S. Pat. Nos. 5,248,415 and 7,374,676, which are hereby incorporated herein by reference.

Filtration chamber 20 is configured to be selectively arranged in a compressed state and an enlarged state. When filtration chamber 20 is in a compressed state, as shown in FIG. 2, fiber bundles 26 are packed together and thereby form a network of fibers through which water must pass. The network of fibers trap dirt and other solids. Over time, the network of fibers becomes filled with solids 24, which reduces the cleaning efficiency of the apparatus. Solids can be readily removed from the fibers by arranging filtration chamber 20 in an enlarged state. When filtration chamber 20 is in an enlarged state, as shown in FIG. 3, fiber bundles 26 may separate from each other and appear as individual fuzzy balls. The density of fibers is reduced, which allows solids 24 to be released from fiber bundles 26 when clean flushing water is injected into solids collection vessel 14. Optionally, air 27 is injected below filtration chamber 20 to agitate the fibers and encourage release of solids 24. The air passes through filtration chamber 20 and is allowed to escape through a vent (not shown) which is temporarily opened near the top of solids collection vessel 14. The flushing water and solids are drawn out of solids collection vessel 14, and the solids can be extracted by any known means.

Solids collection vessel 14 is a pressure vessel configured to maintain the water at an elevated pressure (above atmospheric pressure) while the water is being filtered in FIG. 2. For example and without limitation, the elevated pressure can be at least 10 psig (170 kPa), at least 50 psig (450 kPa), 10 to 1000 psig (170 to 7000 kPa), or 10 to 150 psig (170 to 1140 kPa). Various seals and valves are used to maintain the internal pressure. Maintaining water at the elevated pressure allows the water to flow through entire system 10 at a relatively high rate. For instance, the density of the coalescing media in hydrocarbon collection vessel 12 may require water to be forced through at high pressure. It may be advantageous to run water at similar pressures within solids collection vessel 14 so that it can be connected to hydrocarbon collection vessel 12 without an intervening collection tank and with minimal pressure regulating equipment.

Still referring to FIGS. 2 and 3, filtration chamber 20 of solids collection vessel 14 includes perforated wall 28. Perforated wall 28 is connected to ram assembly 30 which is configured to move perforated wall 28 toward an opposite wall of filtration chamber 20. Ram assembly 30 includes plunger shaft 32 which can be moved down, which pushes perforated wall 28 down onto filtration media 22, and moved up, which pulls perforated wall 28 away from filtration media 22. Ram assembly 30 includes hydraulic actuator 34, motor, or other device configured to move plunger shaft 32. Opposite wall 36 is also perforated. The perforations in walls 28 and 36 are sized to allow water, dirt and other solids to pass through while preventing fiber bundles 26 from escaping out of filtration chamber 20.

Solids collection vessel 14 includes inlet 40 for providing water, which contains solids and hydrocarbon contaminants entrained and/or emulsified in the water, to plenum 42 located below filtration chamber 20 and filtration media 22. Outlet 44, which is for removing water from which the solids have been removed, is disposed above filtration chamber 20 and filtration media 22. Solids collection vessel 14 includes various valves 46 for regulating the flow of water into and out of solids collection vessel 14 when solids 24 are being filtered out of the water. Valves 46 also regulate the flow of clean flushing water (and optionally air) into and out of solids collection vessel 14 when solids 24 are being flushed out of filtration media 22.

Referring again to FIG. 1, hydrocarbon collection vessel 12 is disposed downstream of solids collection vessel 14. Hydrocarbon collection vessel 12 is configured to receive the water from which solids have been removed. Hydrocarbon collection vessel 12 can be as described in U.S. Pat. No. 7,297,279, which is hereby incorporated herein by reference.

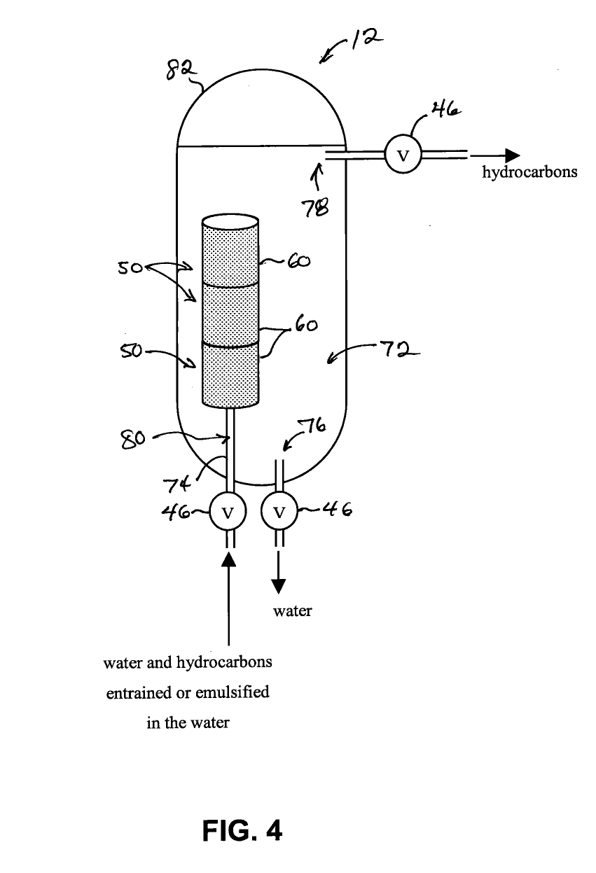

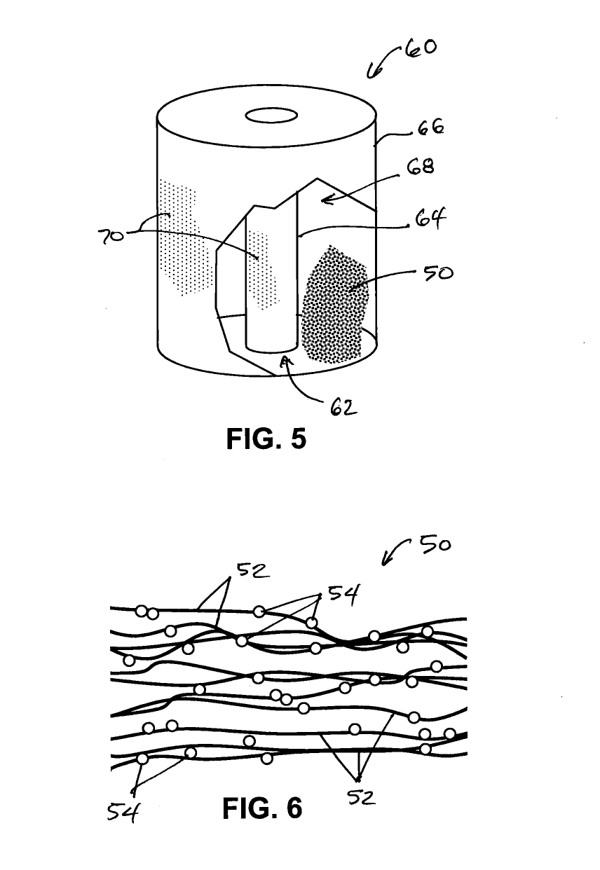

As shown in FIGS. 4 and 5, hydrocarbon collection vessel 12 contains coalescing media 50 which is capable of coalescing the hydrocarbon contaminants to facilitate separation of the hydrocarbon contaminants from the water. As shown for example in FIG. 6, coalescing media 50 includes fibers 52 and polymer particulates 54 which are carried on and distinct from fibers 52.

Fibers 52 are non-woven. Fibers 52 are preferably flexible with a thickness from 1 to 35 denier, and more narrowly from 1 to 10 denier. Fibers 52 may include polyester fibers (e.g., polyethylene terephthalate), nylon fibers (e.g., such as poly(hexamethylene adipamide)), fibers made of polyethylene or poly propylene homopolymers or any copolymer thereof, cellulose triacetate fibers, acrylic fibers (such as polyacrylonitrile, polyacrylate, and polymethacrylate fibers), p-aramid fibers, and/or combinations thereof. Fibers 52 can be non-absorbent (incapable of absorbing liquids and hydrocarbons).

Coalescing media 50 can be made by sprinkling polymer particulates 54 onto fibers 52. Typically no adhesive is required to secure polymer particulates 54 onto fibers 52. Polymer particulates 54 are held in place on fibers 52 solely by contact with fiber edges. Polymer particulates 54 can be foamed polyisocyanurates. Polymer particulates 54 can be foamed polyurethane. Each polymer particulate 54 can have a particle sizes from 0.04 mm to 1.5 mm. Materials, densities, and other characteristics of coalescing media 50 and its fibers 52 and particulates 54 can be as described in U.S. Pat. No. 7,297,279.

As shown in FIG. 4, hydrocarbon collection vessel 12 may contain one or more canisters 60. As shown in FIG. 5, each canister 50 includes canister inlet 62 for receiving water from which solids have been removed. Each canister 60 includes perforated pipe 64 coupled to canister inlet 62. Canister 60 also includes cylindrical wall 66 surrounding perforated pipe 64. Perforated pipe 64 and wall 66 form annular space 68 within the canister, and coalescing media 50 is contained in annular space 68 between perforated pipe 64 and wall 66. Coalescing media 50 is partially shown at only a portion of annular space 68 for ease of illustration, though it is to be understood that coalescing media 50 fills the entire annular space 68.

Perforations (holes) 70 are partially shown at only portions of pipe 62 and wall 66, though it should be understood that the perforations may be formed and distributed evenly on all surfaces of pipe 62 and wall 66. Perforations 70 in pipe 64 allow water and hydrocarbons entrained and/or emulsified in the water to enter annular space 68. Perforations 70 in wall 66 allow for release of the water and coalesced hydrocarbon contaminants into cavity 72 (FIG. 4) within hydrocarbon collection vessel 12. Preferably, perforations 70 are sized smaller than polymer particulates 54 to prevent polymer particulates 54 from escaping into cavity 72. Cavity 72 is configured to allow the coalesced hydrocarbon contaminants to float above the water.

In FIG. 4, hydrocarbon collection vessel 12 includes conduit 74 which delivers water to perforated pipe 64 of each canister 60. When canisters 60 are stacked as shown, perforated pipe 64 of a lower canister is connected to perforated pipe 64 of the canister above. Water and hydrocarbons entrained and/or emulsified in the water flow radially outward from perforated pipe 64 and through coalescing media 50. Water continues to flow radially outward together with coalesced hydrocarbon contaminants through perforated wall 66.

Hydrocarbon collection vessel 12 includes water outlet 76 for discharging water and hydrocarbon outlet 78 for discharging coalesced hydrocarbon contaminants that have floated above the water in cavity 72. Water outlet 76 is disposed at an elevation below the coalescing media 50. Hydrocarbon outlet 78 is disposed at an elevation above the coalescing media 50.

Although three canisters 60 are illustrated in FIG. 4, hydrocarbon collection vessel 12 may include a lesser or greater number of canisters 60 depending on the water flow requirements and space restrictions of a particular installation. For example, the water flow at point 80 in conduit 74 may split into two or more branches, with each branch having one or more canisters 60. Hydrocarbon collection vessel 12 includes lid 82 which can be opened to allow for maintenance, such as removal and replacement of canisters 60 if necessary. Hydrocarbon collection vessel 12 includes various valves 46 for regulating the flow of water into and out of the vessel and flow of hydrocarbons out of the vessel.

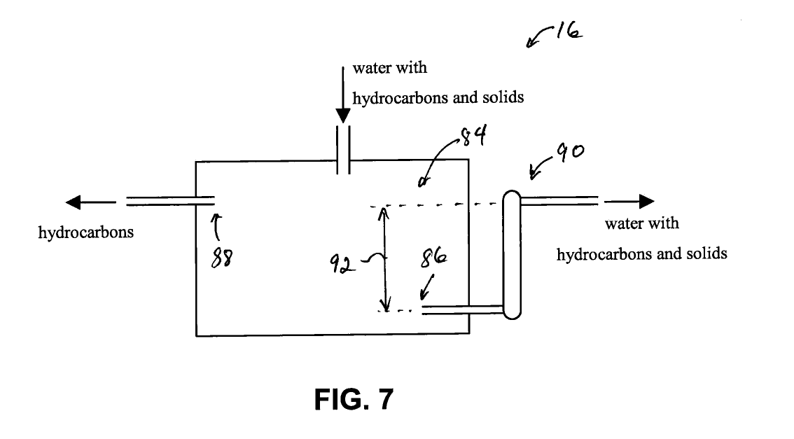

As indicated above, system 10 optionally includes sump tank 16 located upstream of solids collection vessel 14. As shown in FIG. 7, tank 16 includes collection chamber 84, water drain aperture 86, hydrocarbon drain aperture 88, and effluent conduit assembly 90. Collection chamber 84 is configured to collect water. Water may stay within collection chamber 84 for a period of time to allow hydrocarbons to float above the water. Hydrocarbon drain aperture 88 is disposed at an elevation above water drain aperture 86.

Effluent conduit assembly 90 is configured to convey water, which contains solids and hydrocarbon contaminants entrained or emulsified in the water, from water drain aperture 86 to solids collection vessel 14 only when liquid level in collection chamber 84 rises to predetermined height 92 above the water drain aperture. This can be accomplished by various means known in the art, such as described in U.S. Pat. No. 7,297,279. Additionally or alternatively, this can be accomplished with the use of a water level detector configured to determine the liquid level in collection chamber 84. The water drained from collection chamber 84 may still contain significant amounts of hydrocarbons which are entrained and/or emulsified in the water. Those hydrocarbon contaminants as well as solids can be removed downstream from sump tank 16 in the manner previously described.

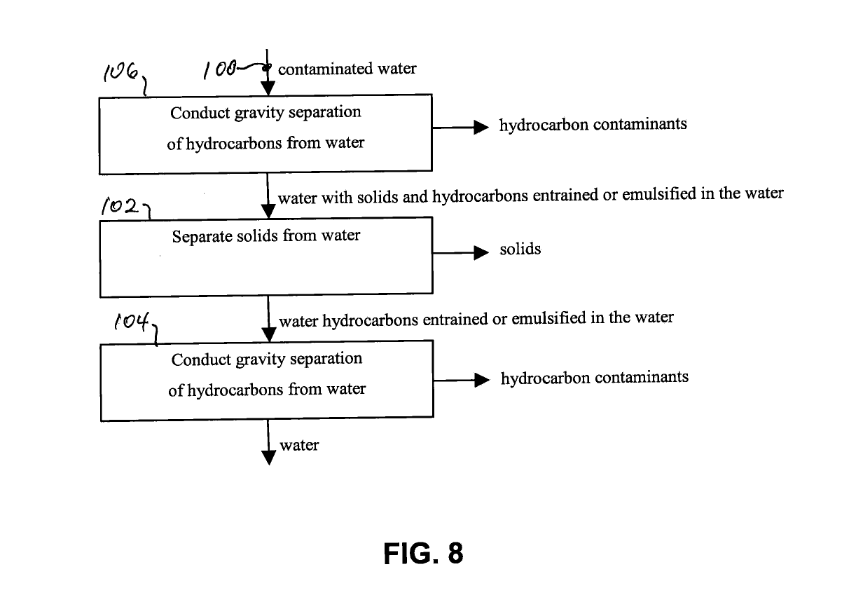

FIG. 8 shows an exemplary method for cleaning water. Although the method is described with reference to the cleaning apparatuses of system 10, it will be appreciated that the method may be performed with other cleaning apparatuses.

At point 100, contaminated water is received. The water contains solids and hydrocarbon contaminants.

Next at block 102, solids are separated from the contaminated water. Solids are removed from the water by trapping the solids in filtration media, such as filtration media 22. The solids are trapped after the filtration media has been compressed, such as by filtration chamber 20 of solids collection vessel 14. Then solids are removed from the filtration media after the filtration media has been decompressed.

Next at block 104, gravity-assisted separation of hydrocarbon contaminants from water is performed. Hydrocarbon contaminants, which may be entrained and/or emulsified in the water, are removed by passing the hydrocarbon contaminants through media capable of coalescing the contaminants, such as coalescing media 50. Then the coalesced hydrocarbon contaminants are allowed to float above the water, such as in cavity 72 of hydrocarbon collection vessel 12.

Trapping the solids in the filtration media at block 102 may include trapping the solids in a plurality of individual fiber bundles, such as fiber bundles 26 in filtration chamber 20 of solids collection vessel 14.

Passing of water through the coalescing media at block 104 may include passing the water radially outward through one or more canisters, such as canisters 60 in hydrocarbon collection vessel 12 which contains the coalescing media.

Optionally at block 106, the method may include performing gravity-assisted separation of hydrocarbon contaminants from the water before solids are removed from the water at block 102. This may be performed by collecting the water in a collection chamber, such as collection chamber 84 of tank 16, and then draining water (with a reduced amount of hydrocarbons) from the collection chamber only after liquid level in the collection chamber has risen to a predetermined.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

1. A system for cleaning water, the system comprising:
a solids collection vessel capable of receiving water containing solids and hydrocarbon contaminants entrained or emulsified in the water, the solids collection vessel including a filtration chamber containing filtration media, the filtration chamber configured to compress the filtration media to allow entrapment of the solids in the filtration media, and to decompress the filtration media to allow flushing of the solids out from the filtration media; and
a hydrocarbon collection vessel disposed downstream of the solids collection vessel and configured to receive the water from which solids have been removed, the hydrocarbon collection vessel containing coalescing media capable of coalescing the hydrocarbon contaminants to facilitate separation of the hydrocarbon contaminants from the water.

2. The system of claim 1, wherein the filtration media includes a plurality of individual filter components, and each component is a bundle of synthetic fibers.

3. The system of claim 1, wherein the solids collection vessel is a pressure vessel configured to maintain the water at a pressure of at least 10 psig (170 kPa) while the water is passing through the filtration media.

4. The system of claim 1, wherein the filtration chamber of the solids collection vessel includes a perforated wall, the perforated wall is connected to a ram assembly configured to move the perforated wall toward another wall of the filtration chamber in order to compress the filtration media.

5. The system of claim 1, wherein the solids collection vessel includes an inlet for providing water, which contains solids and hydrocarbon contaminants entrained or emulsified in the water, to a plenum located below the filtration chamber and the filtration media, the solids collection vessel further includes an outlet for removing water from which the solids have been removed, and the outlet is disposed above the filtration chamber and the filtration media.

6. The system of claim 1, wherein the coalescing media includes fibers and polymer particulates carried on and distinct from the fibers.

7. The system of claim 6, wherein the fibers are non-woven, each fiber has a thickness from 1 denier to 10 denier, and each polymer particulate has a particle size from 0.04 mm to 1.5 mm.

8. The system of claim 1, wherein the hydrocarbon collection vessel contains a canister, the canister includes a canister inlet for receiving water from which solids have been removed, the canister further including a perforated pipe coupled to the canister inlet, the canister further including a perforated wall surrounding the perforated pipe, the coalescing media is contained between the perforated pipe and the perforated wall, the perforated wall includes perforations for releasing water and coalesced hydrocarbon contaminants into a cavity within the hydrocarbon collection vessel, and the cavity is configured to allow the coalesced hydrocarbon contaminants to float above the water.

9. The system of claim 1, wherein the hydrocarbon collection vessel includes a water outlet for discharging water and a hydrocarbon outlet for discharging coalesced hydrocarbon contaminants that have floated above the water, the water outlet is disposed at an elevation below the coalescing media, and the hydrocarbon outlet is disposed at an elevation above the coalescing media.

10. The system of claim 1, further comprising a tank disposed upstream of the solids collection vessel, the tank including a collection chamber, a water drain aperture, a hydrocarbon drain aperture disposed at an elevation above the water drain aperture, and an effluent conduit assembly, the collection chamber is configured to collect water, the effluent conduit assembly is configured to convey water, which contains solids and hydrocarbon contaminants entrained or emulsified in the water, from the water drain aperture to the solids collection vessel only when liquid level in the collection chamber rises to a predetermined height above the water drain aperture.

11. A method for cleaning water, the method comprising:
receiving water containing solids and hydrocarbon contaminants entrained or emulsified in the water; followed by
removing the solids from the water, the removing of solids including trapping the solids in filtration media after the filtration media has been compressed, and flushing the solids from the filtration media after the filtration media has been decompressed; and
removing the hydrocarbon contaminants from the water, the removing of hydrocarbon contaminants including passing the hydrocarbon contaminants, which are entrained or emulsified in the water, through coalescing media, followed by allowing coalesced hydrocarbon contaminants, which were coalesced by the coalescing media, to float above the water, and followed by discharging the coalesced hydrocarbon contaminants separately from the water.

12. The method of claim 11, wherein trapping the solids in filtration media includes trapping the solids in a plurality of individual filter components, and each component is a bundle of synthetic fibers.

13. The method of claim 11, wherein trapping the solids in filtration media is performed while passing the water through the filtration media while the water is at a pressure of at least 10 psig (170 kPa).

14. The method of claim 11, wherein the removing of solids includes moving a perforated wall to compress the filtration media.

15. The method of claim 11, wherein the removing of solids includes providing the water, which contains solids and hydrocarbon contaminants entrained or emulsified in the water, to an area below the filtration chamber and the filtration media, and the removing of hydrocarbon contaminants is performed on water taken from an area located above the filtration chamber and the filtration media.

16. The method of claim 11, wherein the coalescing media includes fibers and polymer particulates carried on and distinct from the fibers.

17. The method of claim 16, wherein the fibers are non-woven, each fiber has a thickness from 1 denier to 10 denier, and each polymer particulate has a particle size from 0.04 mm to 1.5 mm.

18. The method of claim 11, wherein the passing of water through the coalescing media includes passing the water through a perforated pipe located within a canister containing the coalescing media, and allowing the water which contains coalesced hydrocarbon contaminants to escape the canister.

19. The method of claim 11, wherein the discharging of the coalesced hydrocarbon contaminants includes discharging water from a first elevation of a collection vessel, and discharging the coalesced hydrocarbon contaminations from a second elevation of the collection vessel above the first elevation.

20. The method of claim 11, the method further comprising, before the removing of solids, collecting water in a collection chamber, and draining water from the collection chamber only after liquid level in the collection chamber has risen to a predetermined level, and then performing the removing of solids on the water which was drained from the collection chamber.
